(19) United States
(12) Patent Application Publication
(10) Pub. No.: US 2013/0177289 A1
(43) Pub. Date: Jul. 11, 2013

(54) INFORMATION PROCESSING APPARATUS AND INFORMATION PROCESSING METHOD

(71) Applicants: Hideo Kataoka, Tokyo (JP); Hideyuki Toma, Kodaira-shi (JP)

(72) Inventors: Hideo Kataoka, Tokyo (JP); Hideyuki Toma, Kodaira-shi (JP)

(21) Appl. No.: 13/608,427

(22) Filed: Sep. 10, 2012

(30) Foreign Application Priority Data
Jan. 6, 2012 (JP) 2012-001637

(51) Int. Cl. H04N 5/445; H04N 5/775

(52) U.S. Cl. 386/230; 348/563; 348/E05.105; 386/E05.07

(57) ABSTRACT

According to one embodiment, an information processing apparatus includes a receiver, a generator, and an output module. The receiver is configured to receive program additional information including operation history information. The generator is configured to generate display information required to display a program guide associated with the program additional information based on the program additional information and program guide information. The output module is configured to output the display information.

### CROSS-REFERENCE TO RELATED APPLICATIONS

This application is based upon and claims the benefit of priority from prior Japanese Patent Application No. 2012-001637, filed Jan. 6, 2012, the entire contents of which are incorporated herein by reference.

### FIELD

Embodiments described herein relate generally to an information processing apparatus and information processing method.

### BACKGROUND

An information playback apparatus such as a television receiver apparatus, disk recording/playback apparatus or the like has a function of receiving a broadcasting program signal and recording the same on a recording medium. An apparatus having a plurality of tuners has a function of simultaneously recording broadcasting program signals of a plurality of channels on a recording medium. Further, it also has a function of recording a broadcasting program signal received based on reserved program data for recording on a recording medium.

When a broadcasting program signal is selected for recording or viewing the broadcasting program signal, preference information is used. For example, preference information is information used for providing, for example, a recommendable program list estimated based on the preference of the user who uses the information playback apparatus. As a method for forming preference information, various types of methods have conventionally been proposed.

A television receiver apparatus can receive and display an electronic program guide (EPG). For example, the EPG includes a list of programs, which are scheduled to be broadcast. The user searches the EPG program list for a desired program, and selects the desired program to reserve recording or viewing of the desired program.

The EPG is substantially uniform except for a display format or the like, and does not include any additional information according to the actions, behaviors, or preferences of the user. For example, the EPG program list does not guide any operation history of programs which were viewed, recorded, or purchased previously. For this reason, the user checks the EPG program list, and judges a program, which is to be recorded or whose viewing is to be reserved while recalling his or her previous actions, behaviors, or the like.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram of an exemplary configuration in accordance with an exemplary embodiment.

FIG. 2 is a diagram of an exemplary internal function (internal block) of a control device illustrated in FIG. 1.

FIG. 3 is an operation-illustrating diagram showing an example of determining a weighting value for a program to create preference information.

FIG. 4 is a diagram of an exemplary block configuration of a portable terminal.

FIG. 5 is a diagram of an exemplary configuration that can commit creation of preference information (recommendable information) for each portable terminal to an external server.

FIG. 6 is a view showing an example of an additional information-appended program guide.

FIG. 7 is a view showing an example of an additional information-appended program guide.

### DETAILED DESCRIPTION

Various embodiments will be described hereinafter with reference to the accompanying drawings.

In general, according to one embodiment, an information processing apparatus includes a receiver, a generator, and an output module. The receiver is configured to receive program additional information including operation history information. The generator is configured to generate display information required to display a program guide associated with the program additional information based on the program additional information and program guide information. The output module is configured to output the display information.

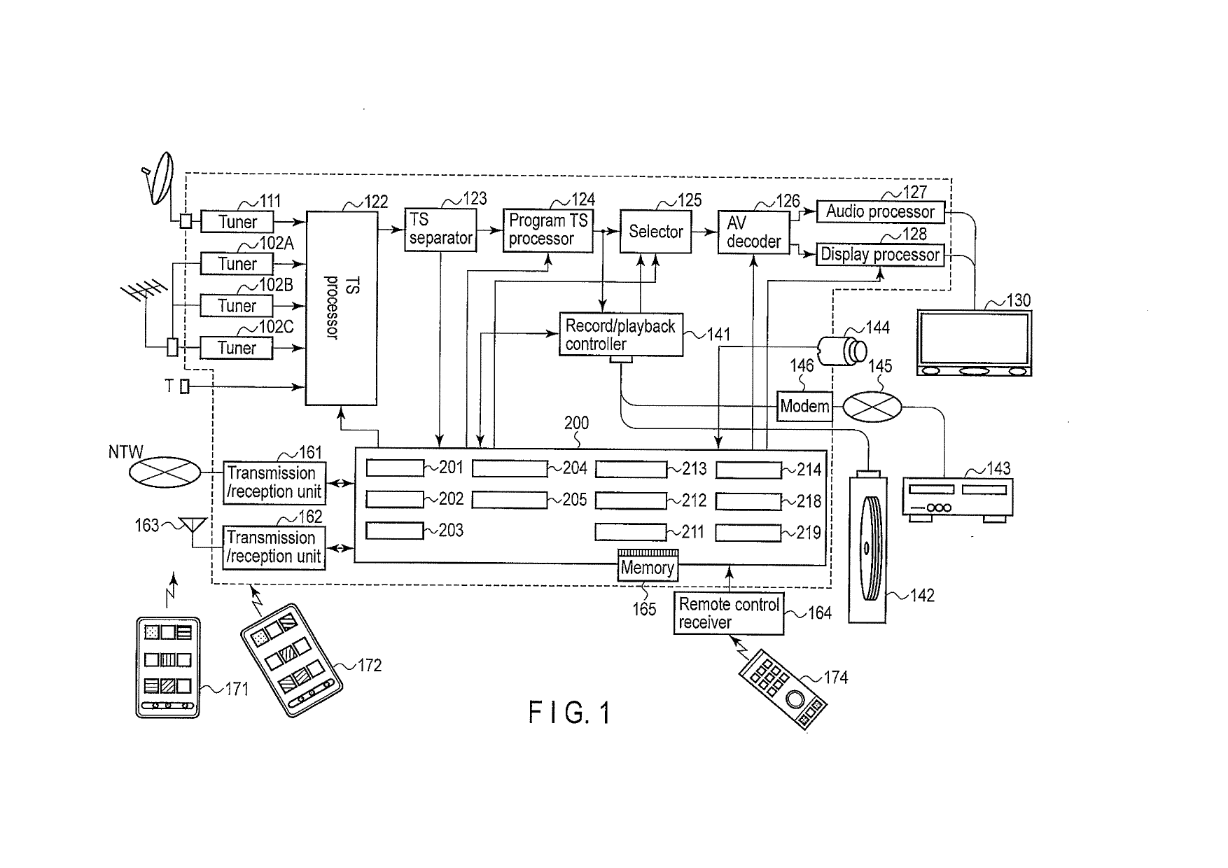

FIG. 1 is a block diagram showing a dialog type digital television receiver apparatus to which the present embodiment is applied.

The receiver apparatus includes a plurality of tuners 102A, 102B, 102C that receive encrypted (or scrambled) digital terrestrial broadcast signals, for example. For example, a tuner 111 is a tuner for Broadcasting Satellite (BS)/Communications Satellite (CS) digital broadcasting reception. In the drawing, four tuners are shown, but it is of course possible to increase the number of tuners.

Signals of broadcasting programs received by the tuners 102A, 102B, 102C and 111 are input to a TS processor 122 functioning as a re-multiplexing unit to re-multiplex Transport Streams (TSs) of plural channels (CH) into one TS.

In the TS output from the TS processor 122, packets of TSs of plural channels are time-divisionally multiplexed. Therefore, if the TS processor 122 is of a four-channel input type, for example, the arrangement of packets is time-divisionally multiplexed at a rate that is five times the rate of inputting to output a multiplexed TS. Then, a control information packet is embedded in the packet arrangement of the multiplexed TS. The control information packet carries control information such as time stamp information of multiplexed channel packets for respective channels, packet arrangement order information and the like.

The TS re-multiplexing system is not limited to the system described here and various methods can be used. The TS re-multiplexed in the TS processor 122 is supplied to a TS separator 123. The TS separator 123 separates an Entitlement Control Message (ECM) that is encoding information and an Event Information Table (EIT) that is a table in which event information such as a program name, performer, starting time and the like is described from a signal of a broadcasting program. Further, it separates electronic program guide (EPG) information or the like and supplies the same to a control device 200. The TS of the broadcasting program is supplied to a program TS processor 124.

In the program TS processor 124, decryption (or de-scramble) or the like is performed for a program stream related to a pay program. A key for decryption is generated by means of the control device 200. The control device 200 generates a key by using information included in ECM, contract information of a memory 165 and the like. A program stream related to a free program is passed without being decrypted.

A program TS output from the program TS processor 124 is supplied to a selector 125 and record/playback controller 141. The selector 125 selects a TS of a program which the user wants to view and supplies the same to an AV decoder 126. Video data included in a video packet of the program TS is encoded based on the Moving Picture Experts Group (MPEG) system, Advanced Video Coding (AVC) system or the like, for example. Further, audio data in an audio packet is encoded based on a Pulse Code Modulation (PCM) system, Dolby system, MPEG system or the like, for example. The AV decoder 126 separates a video packet of a program and an audio packet and decodes data items of the respective packets based on the corresponding systems.

The volume and quality of the decoded audio data are adjusted in an audio processor 127 and then the data is supplied to a speaker system. The picture quality, coloring, display scale, the number of lines, the resolution and the like of the decoded video data are adjusted in a display processor 128 and then the data is supplied to a display 130. Control data items for the audio processor 127 and display processor 128 are provided from the control device 200.

The record/playback controller 141 can supply the program TS from the program TS processor 124 to a hard disk drive 142 and/or disk record/playback apparatus 143. The hard disk drive 142 is always connected to the record/playback controller 141 and can record received broadcasting programs of plural channels for one to two months, for example. The disk record/playback apparatus 143 can play back removable disks such as DVD, BD or record signals on the disks. The disk record/playback apparatus 143 is connected to the record/playback controller 141 via a network (home network) 145 and modem 146 and can function as a home server.

A video camera 144 can photograph a viewer who views the display 130 and the surroundings thereof. A photographed signal can be managed for storage, playback and monitoring, at the control device 200.

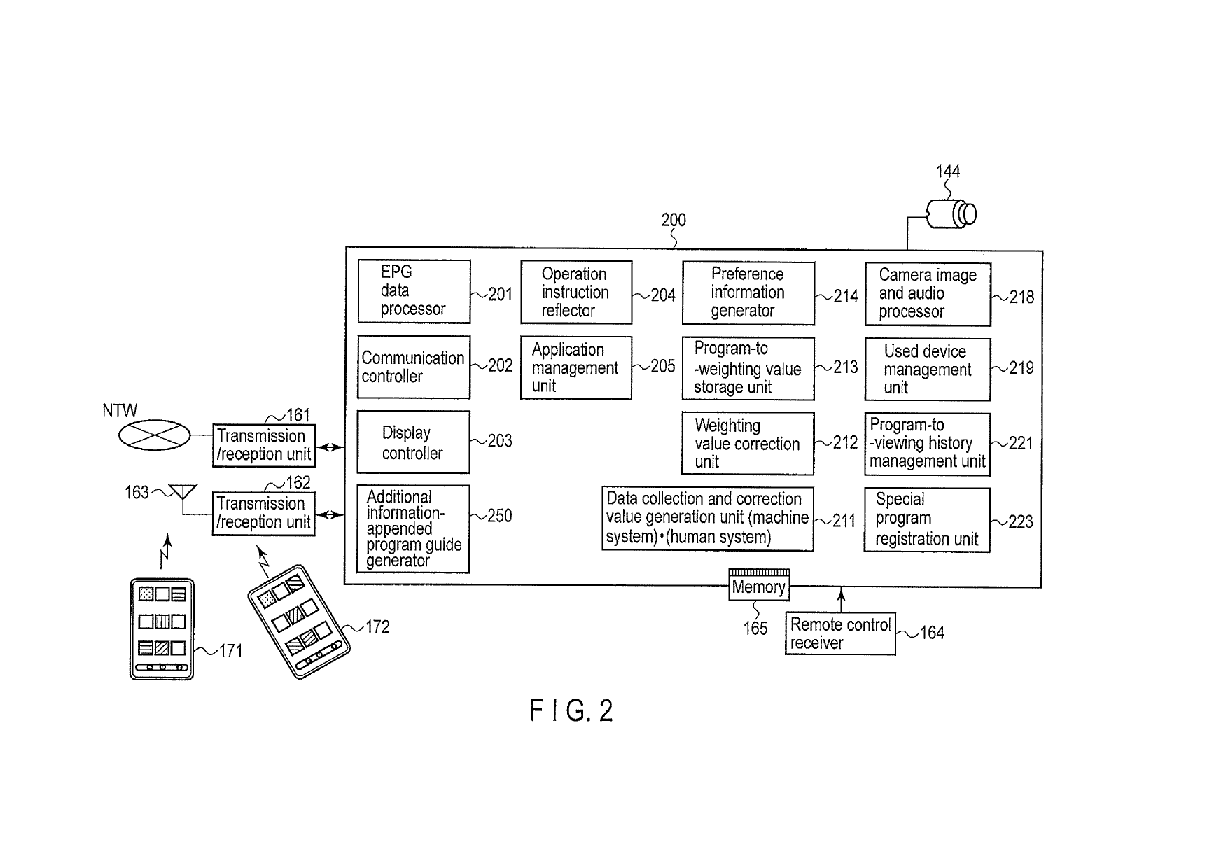

The control device 200 is explained with reference to FIG. 1 and FIG. 2.

The control device 200 includes an EPG data processor 201. By utilizing EPG data related to the past, present and future programs, the EPG data processor 201 can manage a program table related to programs already broadcast in the past and already stored in the hard disk drive 142, a program table related to programs that are now broadcast and a program table related to programs that will be broadcast in the future (approximately one month), in connection with one another.

Further, the EPG data processor 201 can add information inherent to the user or viewer to EPG data. The information inherent to the user or viewer may be described as follows, for example. When a broadcasting program is a movie, the information inherent to the user is information indicating that the user has purchased or orders a DVD or BD on which the movie is recorded. Further, when a broadcasting program is obtained by recording a concert of an orchestra, the information is information indicating that the user has purchased an appreciation ticket for the concert of the orchestra. The information items are information items collected by a data collection and correction value generation unit 211 that will be described later.

Further, the control device 200 includes a communication controller 202. The communication controller 202 controls input/output data of transmission/reception units 161, 162 and remote control receiver 164 connected to the control device 200.

The transmission/reception unit 161 can be connected to network NTW and, for example, connected to a server on the Internet. The transmission/reception unit 162 is used for short-distance radio communication and can communicate with portable terminals 171, 172 via an antenna 163. The transmission/reception unit 162 may communicate with the portable terminals 171, 172 via a relay (access point). In this case, wireless or wired communication can be performed if the transmission/reception unit 162 is connected to the relay. Further, although not shown in the drawing, a transmission/reception unit connected to the home network to which a home server is connected may be provided on the television receiver apparatus. As a portable terminal, a cellphone, personal computer, tablet computer, game console and the like can be used.

The remote control receiver 164 can receive an operation signal from a remote controller 174. The operation signal is analyzed in an operation instruction reflector 204. The control device 200 can reflect the operation corresponding to the operation signal to a system.

In this embodiment, the operation signal can be supplied to the control device 200 from the portable terminals 171, 172 via the transmission/reception unit 162.

The portable terminals 171, 172 can access the server via an Internet, base station not shown in the drawing or the like. Not only content provided by the server but also various applications and game software can be downloaded and transferred to the control device 200 via the transmission/reception unit 162. When content or application or game software is transferred from the portable terminal 171 or 172 to the control device 200, the communication controller 202 is operated. When content (for example, moving pictures) is transferred, the communication controller 202 provides the received content to the record/playback controller 141. The record/playback controller 141 can record the received content (moving picture) on the hard disk drive 142. In the hard disk drive 142, content is managed by use of a content file. When an application or game software (upgraded application, new application or new game software) is transferred from the portable terminal, the communication controller 202 supplies the received application or game software to the record/playback controller 141. The record/playback controller 141 can record the received application or game software on the hard disk drive 142. In the hard disk drive 142, the application and game software are managed by use of an application file and game software file.

The types and versions of the application and game software are also managed in an application management unit 205 in the control device 200. When menus of the application and game software are displayed, data of the application management unit 205 is utilized.

To-be-displayed menu screen data, program table screen data and the like are stored in or managed by means of a display controller 203. When the menu or program table is displayed, menu screen data or program table screen data is read from a data storage unit (memory or hard disk) and supplied to the display processor 128 under control of the display controller 203. As a result, the menu screen or program table screen is displayed on the display 130.

To-be-displayed menu screen data, program table screen data and the like can also be transmitted to the portable terminal 171 or 174. When the portable terminal 171 or 174 requests menu screen data, program table screen data or the like, the display controller 203 can transmit the menu screen data or program table screen data. The portable terminal 171 or 174 can display menu screen data or program table screen data on a touch panel screen and the user can give an operation instruction to the television receiver apparatus by touching an operation button displayed on the touch panel screen.

The control device 200 includes a data collection and correction value generation unit 211. The data collection and correction value generation unit 211 can generate a correction value of a weighting value for a program based on various operation data items (recording, playback, skip, erase, copying, programmed recording and the like) caused in the device and communication data fetched from the exterior. The weighting value and correction value are explained more in detail later. The correction value generated from the data collection and correction value generation unit 211 is used to correct the weighting value of the program by means of a weighting value correction unit 212. The corrected weighting value is transmitted to the program-to-weighting value storage unit 213 and stored therein.

The weighting value for the program is used when preference information (recommendable program list) for the program is generated in the preference information generator 214. The level of preference corresponding to the weighting value is set for the program. Then, for example, program names are arranged in the order of larger weighting values and can be displayed on the display 130 as a recommendable program list. The recommendable program list is updated once a day or once on every two or three days. The recommendable program list is transferred to the portable terminal in response to a request of the portable terminal and can be displayed on the display of the portable terminal. The user can perform the playback operation of a favorite program on the screen of the portable terminal.

The control device 200 includes a camera image and audio processor 218. The camera image and audio processor 218 can fetch image data from the camera 144, for example, and perform various processes according to an application. For example, the processing unit can identify a fetched face image of a viewer and create a table in which the face image and program information viewed by the viewer corresponding to the face image are related to each other. Further, the processing unit can fetch audio data from a microphone that is provided integrally with or separately from the camera 144 and analyze the same. For example, the processing unit can create a table in which a program name and scene obtained when the voice of the viewer (laughing voice) becomes loud are related to each other.

The control device 200 includes a used device management unit 219. The used device management unit 219 has a used device registration application and can start the used device registration application by means of a remote controller 174, for example. If the portable terminal 171 or 174 is operated or the hard disk drive 142 or disk record/playback apparatus 143 is connected when the used device registration application is started, the above device can automatically be registered as a peripheral device.

Since the portable terminals 171, 174 have identification (ID) information, ID is registered as a peripheral device.

The data collection and correction value generation unit 211 is operated together with the communication controller 202 and has a function of detecting portable terminals present in the communication area. When detecting a portable terminal, the data collection and correction value generation unit 211 can request communication data remaining in the memory of the portable terminal. The communication data is blog data, mail data or retrieval data. In the memory of the portable terminal, trace (history) data of the operation of various content remains. Such history data includes identification data of the content. The history data is also collected as communication data by the data collection and correction value generation unit 211.

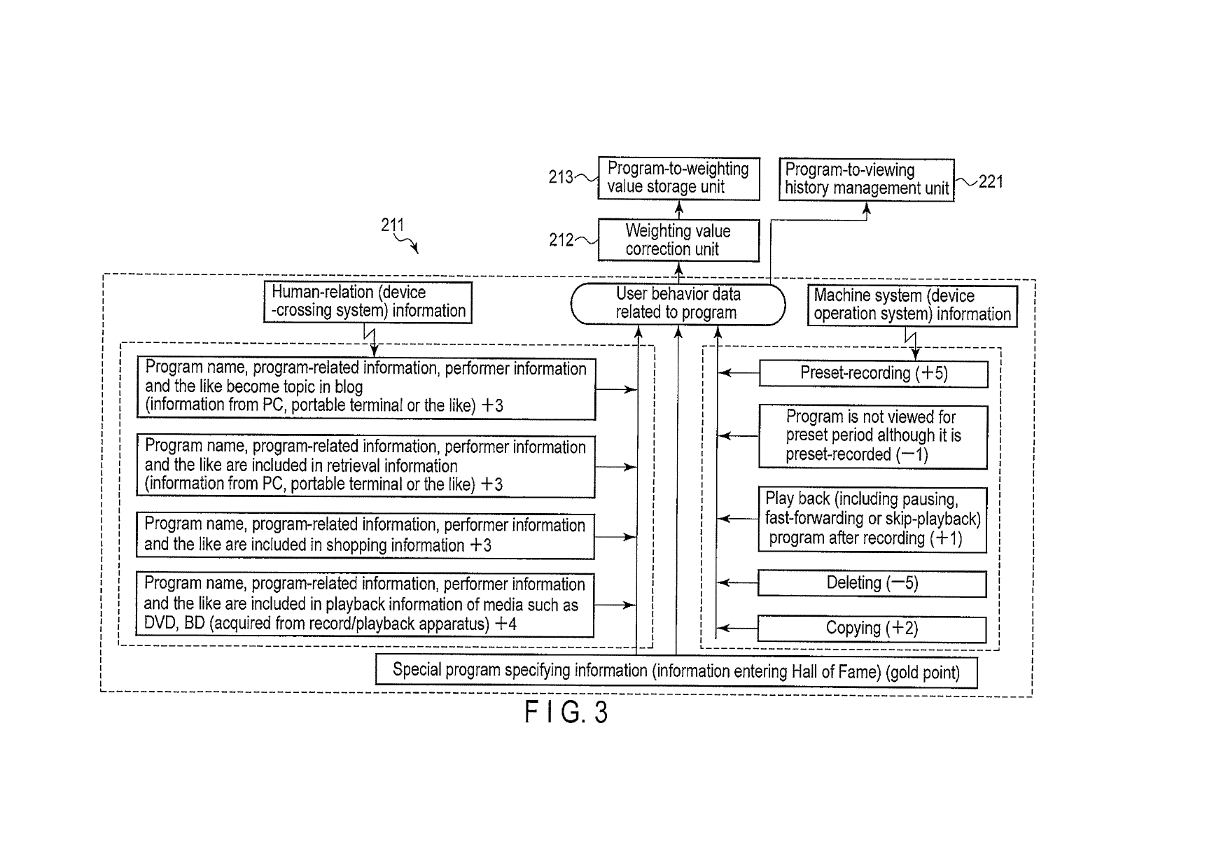

In FIG. 3, one of the characteristic configurations of the above apparatus is shown. The data collection and correction value generation unit 211 collects data of the user behavior related to the program and generates a correction value of a weighting value for the program. The user behavior can be classified into a machine system (that may also be referred to as a machine operation system) and a human-relation system (that may also be referred to as a device-crossing system or social system). The human-relation system corresponds to the operation of the user (portable terminal) who contacts a social medium (for communication) and performs a communication.

The machine system includes behaviors of preset-recording a program, not viewing (playing back) the program for a preset period (for example, within one week) although it is preset-recorded, playing back (including pausing, fast-forwarding or skip-playback) the program after recording, deleting the program or copying the program. The behaviors can be determined by identifying an instruction signal (instruction) input to the operation instruction reflector 204.

The data collection and correction value generation unit 211 determines the instruction signal and generates the following correction values (points), for example. When a certain program is preset-recorded, a point of . . . +5 is generated. When a program is not viewed (played back) for a preset period (for example, within one week) although it is preset-recorded, a point of . . . −1 is generated. When a program is played back (including being paused, fast-forwarded or skip-played back) after recording and then deleted, a point of . . . +1 is generated. In the case of copying, a point of . . . +2 is generated. The point, that is, a correction value is used to correct the weighting value of the program in the weighting value correction unit 212. The corrected weighting value is stored in the program-to-weighting value storage unit 213. The value of the point is not limited to the value shown here and it should be understood that it is presented only as one example. Further, the points may be more finely classified to generate plus points or minus points. By statistically collecting the points, the preference of the viewer for the program can be finely understood. Further, viewing history information for the program is collected and stored in a program-to-viewing history management unit 221. The viewing history is kept held for about one month or two months and then sequentially erased starting from the oldest one. When a viewer (user) recognition function is provided, the viewing history may be classified for each user.

Next, communication data is analyzed in the human-relation system and a correction value of a weighting value is generated. For example, the following points are generated. That is, a point (correction value) of . . . +3 is generated when a program name, program-related information and performer information become the topic in the blog.

A point (correction value) of . . . +3 is generated when a program name, program-related information and performer information are included in retrieval information.

A point (correction value) of . . . +3 is generated when a program name, program-related information and performer information are included in retrieval information in shopping information.

A point (correction value) of . . . +3 is generated when a program name, program-related information and performer information are included in retrieval information in playback information of media such as DVD and BD.

Further, a content purchasing example based on video-on-demand (VOD) is given as a content purchasing example. Further, there is a content purchasing example of CD, DVD, article and game. In order to collect the purchasing histories, for example, Internet access information (information related to URL) of the portable terminal (including a personal computer) is analyzed. Based on the analysis, various order information items and mail-order sales providers (for example, Amazon [registered trademark] or the like) are detected. Such purchasing information is effective when content in which the user is particularly interested is detected.

Therefore, when the above purchasing information (purchasing behavior) is detected, the maximum point (for example, +5) is generated.

Further, the above program-to-weighting value table may be classified for each identification (ID) information of the portable terminal. By making the classification, preferential information of the individual exclusively using the portable terminal can be more precisely formed.

Additionally, the database of face image data of performers and actors and the names thereof or the database of cars and the names of companies may be formed and the database may be used. For example, when face image data of a performer or actor is input to the data collection and correction value generation unit 211 from the external portable terminal, whether or not the input face image data is registered in the database is determined. If the input face image data is registered in the database, it is determined that the user is particularly interested in a program in which the performer or actor appears and the weighting value of the program may be increased. Also, in this case, a program-to-weighting value table classified for the respective portable terminals 171, 172 is formed. Further, a program-to-weighting value table classified for the respective users or respective portable terminals may be formed. Plural preference information items formed based on the above classification correspond to the respective users or respective portable terminals.

As described above, the present embodiment utilizes information of the machine system or human-relation system as the filtering method.

Generally, the percentage of users who view a program because they like the program is approximately 20%. The percentage of fans for a certain program is approximately 20%. In order to estimate the preference of the viewers of this type, the filtering method based on the machine system is suitably used.

However, it is often the case for the other viewers of approximately 80% to leave the television receiver apparatus on without particular aim. For example, the television receiver apparatus is set on without aim to display a program in many cases while the viewer is doing housework, performing the operation or sitting in a family circle. In order to estimate the preference of the viewers of this type, the filtering method based on the machine system cannot be suitably used.

Therefore, in the present embodiment, attention is paid to the fact that the user's behaviors are dispersed. That is, it is impossible to estimate the real preference of the user simply based on the user's behavior for a preset apparatus (for example, home television apparatus). In other words, the user's behavior is not performed only for the preset apparatus.

The user may communicate with social media and provide the topics of program names, performers and the like.

In the above embodiment, communication data is fetched and key data is extracted from the fetched data. Then, data (program name, the name of a performer of the program, face image data of the performer, program-related information) related to the program is detected. For example, the program-related information is a broadcasting station name, channel number, broadcasting time slot and the like. When data related to the program is detected, it can be estimated that the user is positively interested in the program. As a result, the preference of the user is emphasized based on the communication data. This resultantly leads to the fact that the preference (the preference that tends to be emphasized by the machine system) based on the behavior of the user who views a broadcasting program aimlessly is relatively suppressed.

In the above example, data items of the machine system (machine operation system) and human-relation system (device-crossing system or social system) are dealt with in parallel. However, the example is not limited to the above data processing method. If a program dealt with in the machine system is present in plural programs detected in the human-relation system, a process of increasing the weighting value may be additionally performed.

Various data classifying methods are provided and the method is not limited to the above classifying method. For example, the classifying method may be performed based on the relationship of the whole data, history data and preference data. The “whole data” is the entire information on the network, for example, and is data acquired from the program information, blog, tweet, network news or the like. The “history data” is data generated based on the behavior of the user and is data generated based on the type of a program that is played back or recorded or a medium that is related to the type of a corresponding program and purchased. The preference data is preference information obtained by adding a weighting value to a program corresponding to key data included in the “history data”. Also, in this case, human-relation information is used.

The apparatus of the disclosure is not limited to the above embodiment. The camera image and audio processor 218 can identify a fetched face image of the viewer and form a table in which the face image and program information which the viewer of the face image has viewed are related to each other. Further, the processor can fetch audio data from a microphone that is provided integrally with or separately from the camera 144 and analyze the same. Therefore, it becomes possible to form preference information for each viewer.

However, when plural viewers are detected, it becomes possible to form common preference information. Further, when the voice of the viewer is recognized and the viewer laughs in a loud voice, an adding point for the program which the viewer views may be generated.

The weighting value may significantly increase and exceed a preset threshold value. Such a program can be dealt with as a special program (or a program entering a Hall of Frame). Program information of the program that enters a Hall of Frame and in which the weighting value exceeds a preset threshold value is registered in a special program registration unit 223. Further, when the program signal is recorded on the hard disk drive 142, for example, an erase inhibition flag is added.

The program name of the program that enters a Hall of Frame can be displayed on the display 130 by operating the portable terminal. Further, the program name of the program that enters a Hall of Frame can be read in response to a request signal from the portable terminal and displayed on the display of the portable terminal.

Program information of a program that enters a Hall of Frame can be registered in response to an operation signal from the portable terminal. The user sometimes wants to deal with a program in which the user himself appears or a program in which the user is particularly interested as a program that enters a Hall of Frame. The user can operate the portable terminal to display the program table in which the program name is described on the display 130, for example, or on the display of the portable terminal. Then, the user can operate a special program registration operation button to register a program in which the user himself appears or a program in which the user is particularly interested as a program that enters a Hall of Frame.

Information that enters a Hall of Frame is not limited to a program name and, for example, a personal name, performer name, article name or the like may be set.

The data collection and correction value generation unit 211 can generate a correction value of a weighting value according to collected data. However, the generation unit may sometimes refuse reception of collected data and may not generate a correction value of a weighting value. In order to perform the above operation, key data (keyword) used to refuse the reception is previously registered by means of the portable terminal. Key data used for refusing the reception is data that offends against social standards and is stored in the data collection and correction value generation unit 211.

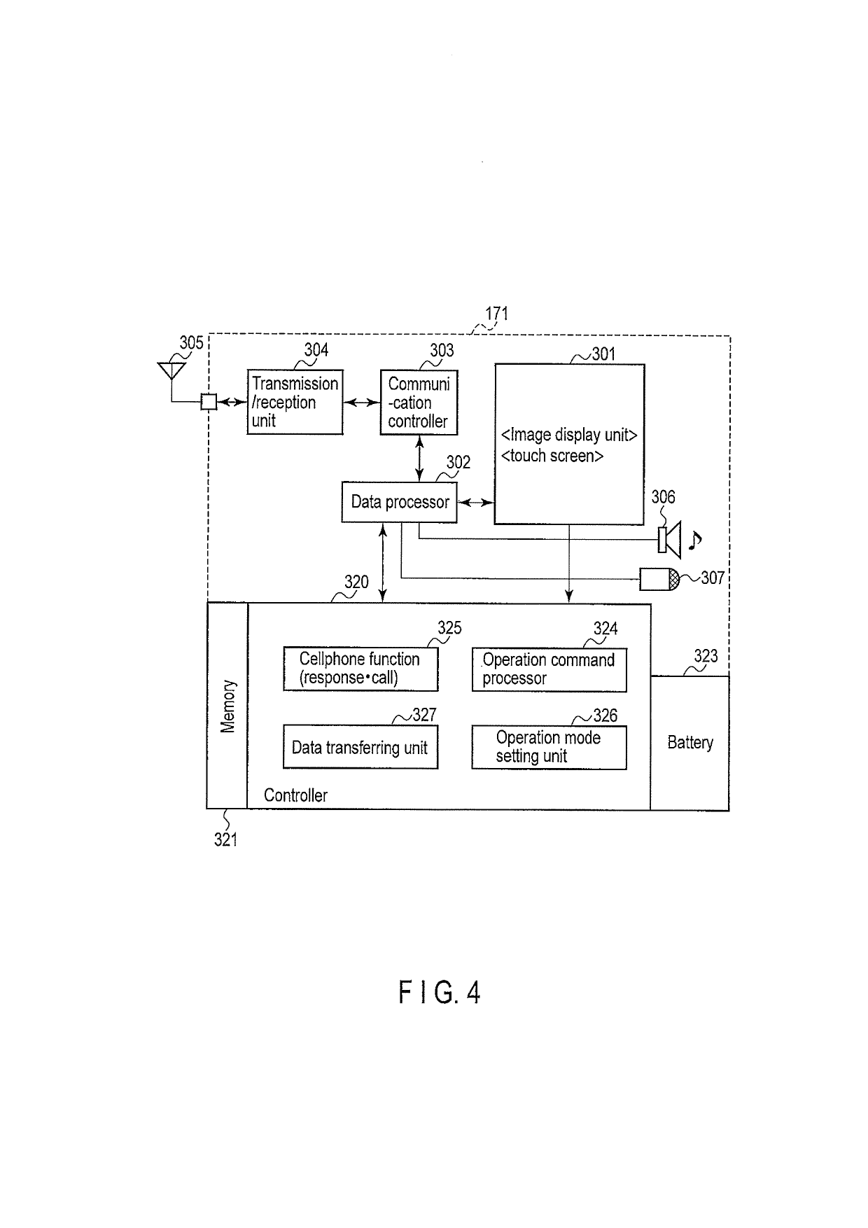

FIG. 4 shows an example of the internal configuration of the portable terminal 171. A display 301 is operated as an image display unit and can be operated as a touch screen. If the user touches a desired item when a menu screen is displayed, the operation input is recognized by means of an operation command processor 324 of a controller 320. For example, the touch operation is the operation input of selecting the phone function, an operation mode setting unit 326 sets the portable terminal 171 in a cellphone mode.

An operation screen for dial inputting is displayed on the display 301. If an operation for dial inputting of a desired address is performed, a cellphone functioning unit 325 transmits a call signal of a communication partner via a data processor 302, communication controller 303 and transmission/reception unit 304. When the line to the communication destination is set in a connection state, a signal from the communication partner is decoded via the transmission/reception unit 304, communication controller 303 and data processor 302. Then, voice data is output from a speaker 306. Voice data is processed by means of the data processor 302 via a microphone 307 and transmitted to the communication controller 303. Then, the data is transmitted as transmission data to the communication partner via the transmission/reception unit 304. A memory 321 is used to temporarily store data or store an application. 323 denotes a battery that is chargeable.

For example, the portable terminal 171 can download content or applications via an Internet. Further, the portable terminal can transfer the downloaded content or applications to the television receiver shown in FIG. 1, for example, based on control of a data-transferring unit 327. In this case, the portable terminal 171 apparently functions as a relay. Further, the portable terminal 171 can request a playback program with respect to the television receiver apparatus. Since the data amount of the playback program transmitted from the television receiver apparatus is relatively large for the portable terminal 171, the portable terminal 171 functions as a monitor without storing the playback program.

The portable terminal 171 can request image data of a program table, playback data of content and control screen data used for controlling the television receiver apparatus with respect to the television receiver apparatus. As the control screen data, for example, data of a menu screen, picture quality adjustment (resolution, luminance or the like) screen, color adjustment screen and volume adjustment screen is provided. When the control screen is obtained, the user can provide various adjustment inputs of the television receiver apparatus via the touch screen of the portable terminal. Further, adjustment data such as adjustment levels thereof can be stored in the memory 321 and used for the next adjustment operation and, for example, adjustment data can be provided with respect to another television receiver apparatus that is registered to be used.

The portable terminal 171 can download content from the external server or television receiver apparatus and display the same on the display 301. When content (moving pictures, photographs, letters, figures and the like) is displayed on the display 301 and if the user's finger touches the face (or the name) of a favorite performer, face image data is processed to be included in the communication data explained before. The user's finger may be moved to draw a circle and surround the face (or the name) of the performer on the screen. An object image is not limited to the face (or the name) of the performer and may be a favorite car or building of the user, a character string of figure in which the user is interested and the like. The operation input is processed by means of the operation command processor 324.

The portable terminal 171 has a short-distance communication function with respect to the television receiver apparatus of FIG. 1. That is, when the data collection and correction value generation unit 211 of the television receiver apparatus detects the portable terminal 171 and requests communication data remaining in the memory, the portable terminal 171 starts a data transferring unit 227 to transmit the communication data. Next, a portable terminal 197 deletes the already-transmitted communication data.

Various methods can be provided as means for transmitting communication data from the portable terminal 171 to the data collection and correction value generation unit 211 of the television receiver apparatus. For example, if the user himself operates the operation button of the portable terminal 171, communication data may be transmitted from the portable terminal 171 to the television receiver apparatus. Further, if the television receiver apparatus is operated by means of the portable terminal 171, communication data may automatically be transmitted to the television receiver apparatus.

As described above, in the present embodiment of the disclosure, history data based on the operation of the portable terminal and history data based on the operation of the television receiver apparatus are present as history data to collected.

Therefore, in this embodiment, history data items of various instruments present in a home can be separately or simultaneously transmitted to the management server. The portable terminal may transmit data to the management server or a television receiver apparatus 100 may transmit data to the management server. In this case, for example, if data in the program-to-viewing history management unit 221 is used, it is convenient. This is because human-relation system information and machine system information are collected in the data of the program-to-viewing history management unit 221. However, in this case, it is supposed that the weighting value is omitted.

The management server can utilize a characteristic detection program, characteristic analysis program and preference information creation program to provide adequate recommendable data to each home as service. The characteristic detection program allocates independent weight to the program, for example, by using viewing history data. For example, the weighting system of the respective items shown in FIG. 3 may be used or another weighting value may be set.

Next, the characteristic analysis program sets an independent preferential order, exception order or the like with respect to each program by using the weighting value and history data for the program. The preference information creation program refers to data of the preferential order and exception order and adds preferential orders, exception orders and the like to plural selected programs to create recommendable information, that is, preference information. The management server returns the created recommendable information to the portable terminal or television receiver apparatus.

Particularly, in the case of this embodiment, as described above, the portable terminal such as a smartphone or tablet computer is used for an auxiliary operation or developmental operation mainly related to content viewing of the television receiver apparatus with a large screen. Then, the operation history caused by using the portable terminal is collected as history data. Therefore, in the data collection and correction value generation unit 211, the viewing history of video content in the home is comprehensively collected based on various operations of plural instruments.

Also, in the above case, if plural portable terminals are used, the viewing history for each portable terminal may be independently collected. If the viewing history for each portable terminal is independently collected, preference information for each of the users having the respective portable terminals can be created.

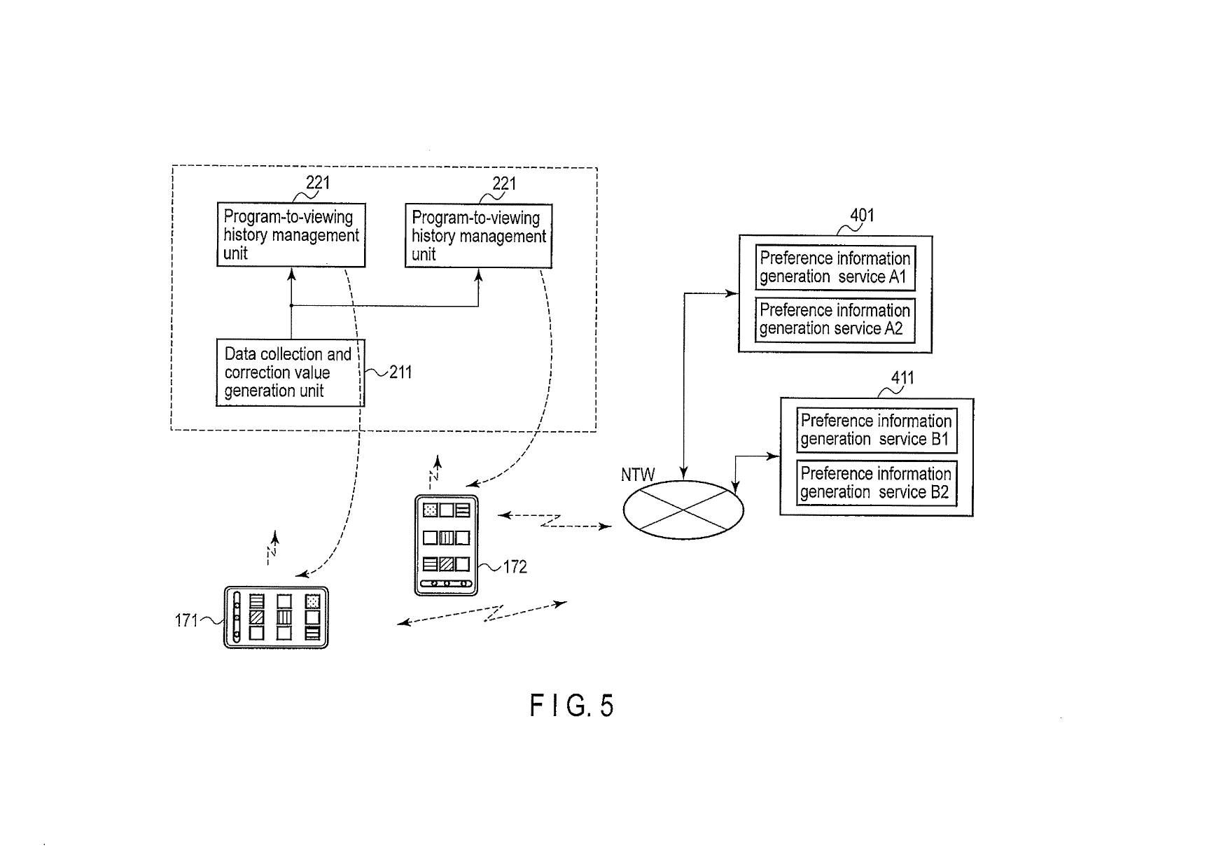

FIG. 5 shows an example in which exclusive program-to-viewing history management units 221, 221 for the portable terminals 171, 172 are provided. That is, FIG. 5 shows an example of the configuration that can commit creation of preference information (recommendable information) for each portable terminal to an external server. The portable terminals 171, 172 can request viewing history data in the program-to-viewing history management units 221, 221 to utilize the viewing history data items. The portable terminals 171, 172 can transmit independent viewing history data items to favorite servers 401, 411 and/or preference information creation services A1, A2, B1, B2 in the servers. The servers 401, 411 and/or preference information creation services A1, A2, B1, B2 in the servers create preference information by using received viewing history data and returns the same to the portable terminal 171 or 172.

Therefore, the portable terminals 171, 172 can acquire preference information items corresponding to the respective viewing history data items. Further, the portable terminals 171, 172 can acquire preference information items from favorite preference information creation services A1, A2, B1, B2. If the user of the portable terminal is dissatisfied with preference information acquired from preference information creation service A1, for example, he can acquire preference information from another preference information creation service A2, B1 or B2. The preference information may be stored in the portable terminal or stored in the television receiver apparatus for each portable terminal.

An output (display) operation of an additional information-appended program guide by the digital television receiver apparatus shown in FIG. 1 will be described below. Note that the output (display) operation of the additional information-appended program guide by the digital television receiver apparatus will be explained, but the portable terminal 171 or 172 (cellphone, tablet computer, or the like) may output (display) an additional information-appended program guide.

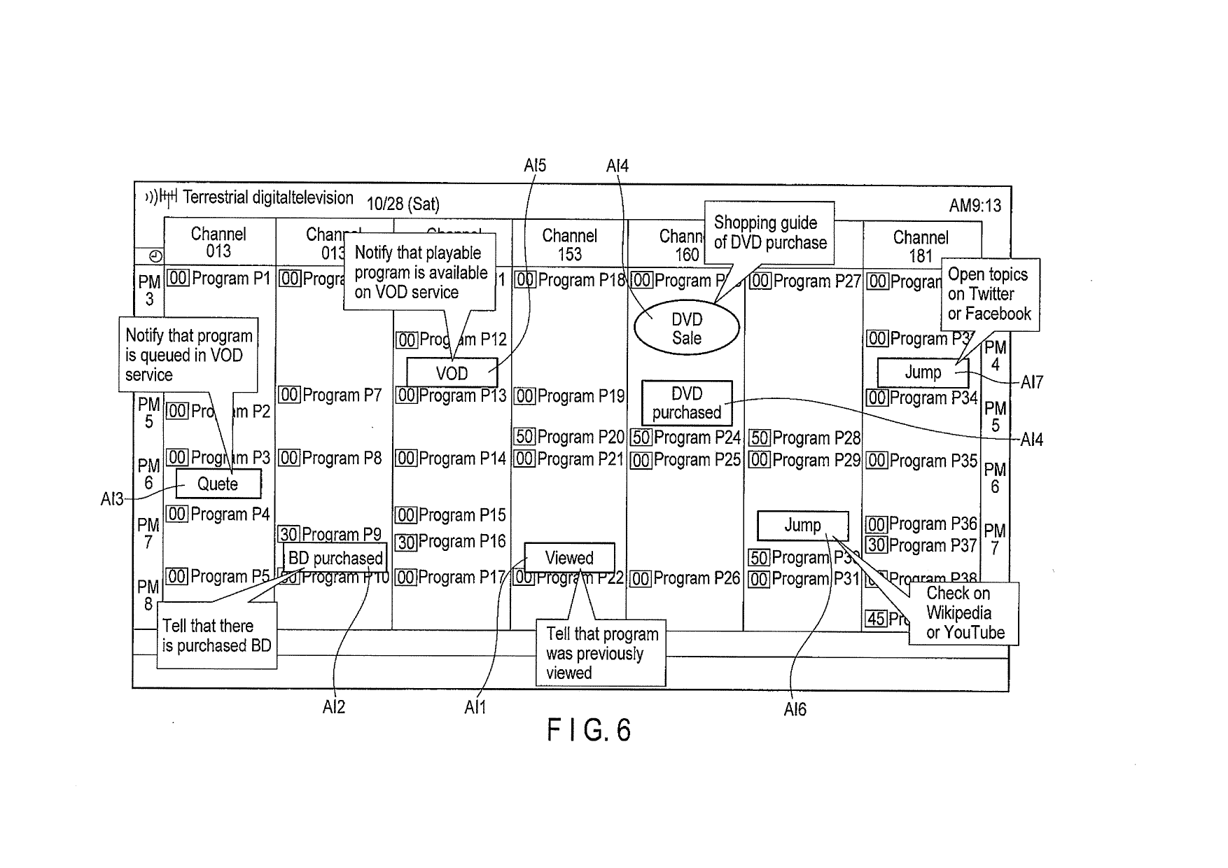

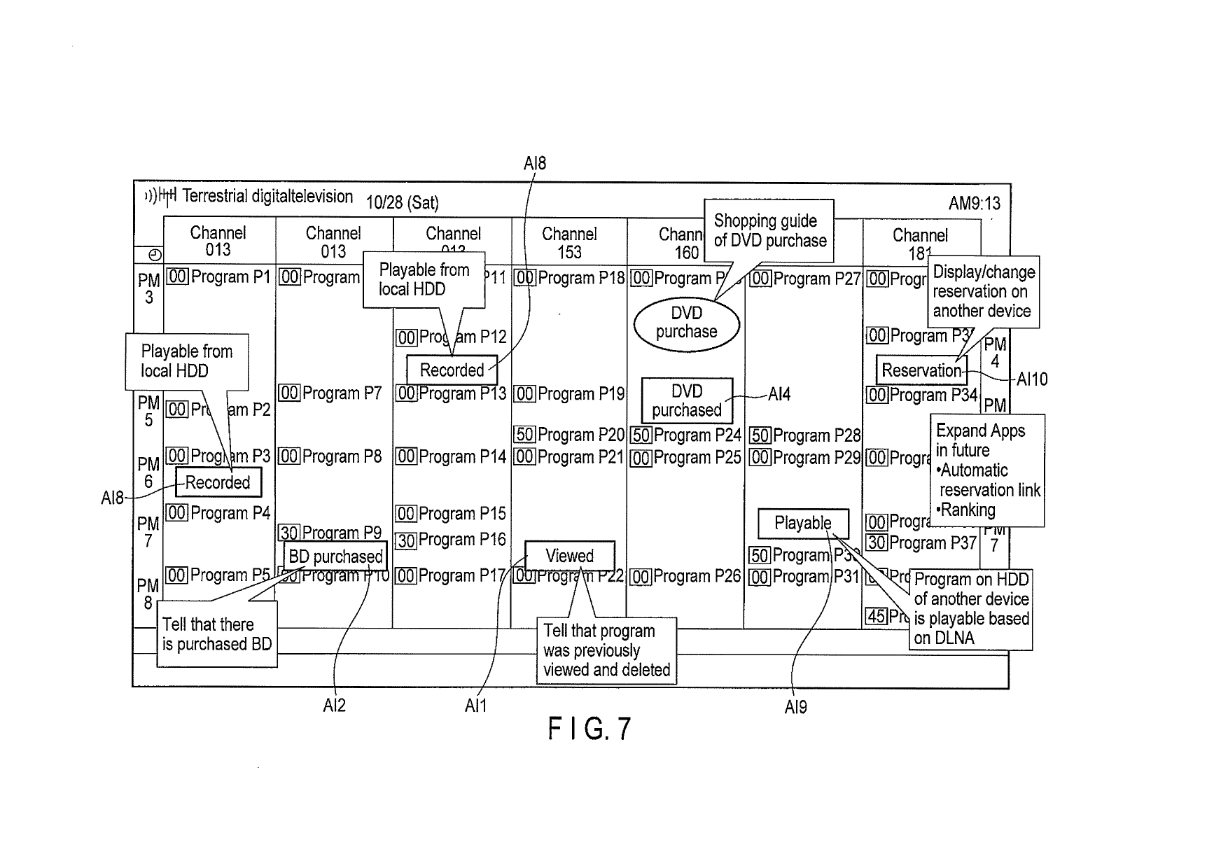

The transmission/reception unit 161 or 162 of the digital television receiver apparatus receives, for example, program additional information (program recording history information, program viewing history information, post-program viewing deletion history information, program purchase history information, program sale information, program streaming distribution information, program streaming distribution purchase information, access information to program related information on a network, and so forth) including operation history information. The control device 200 (additional information-appended program guide generator 250) generates display information required to display a program guide associated with the program additional information based on the program additional information and program guide information (the EPG, program recording list, or the like), and the display processor 128 outputs the display information. Thus, the display 130 displays, for example, an additional information-appended program guide shown in FIG. 6 or 7. Alternatively, the portable terminal 171 or 172 includes the same arrangement and functions as those of the digital television receiver apparatus, and displays the additional information-appended program guide shown in FIG. 6 or 7.

The program additional information may include all or some of the aforementioned items of preference information. That is, the program additional information may include all or some items of history information based on the user's actions or behaviors. For example, the control device 200 (additional information-appended program guide generator 250) may generate the display information required to display the additional information-appended program guide using all items of received history information, or may select some items of effective history information based on the aforementioned preference information (levels of preference), and may generate the display information required to display the additional information-appended program guide using some items of selected effective history information.

Details of the generation and output (display) operations of the additional information-appended program guide will be described below.

(Collection and Output of Program Additional Information)

For example, the digital television receiver apparatus receives the program additional information provided from the external server, portable terminal 171 or 172, or the like. The program additional information includes, for example, first program identification information (program title or ID). The digital television receiver apparatus acquires program guide information (EPG) from a broadcast signal or via a network, and holds program display information required to display a list of a plurality of recorded programs. For example, the control device 200 (additional information-appended program guide generator 250) generates display information required to display a program guide including a first program cell associated with the program additional information based on first program identification information of the first program cell included in the program guide information.

Then, for example, when the digital television receiver apparatus receives program additional information associated with a first program, it can display the program guide including the first program cell by associating the program additional information with the first program cell corresponding to the first program. For example, when the user selects the first program cell on the program guide using a cursor, pointer, or the like, the digital television receiver apparatus outputs (pops up) the program additional information associated with the first program cell in response to the selection. Alternatively, the digital television receiver apparatus outputs (displays) an icon (program additional information) associated with the first program cell.

(Collection and Output of Program Recording History Information)

For example, when the portable terminal 171 or 172 issues a recording or reserved-recording instruction of a second program (broadcast program or the like) to the digital television receiver apparatus, the recording/playback controller 141 of the digital television receiver apparatus acquires the second program based on the recording or reserved-recording instruction of the second program, and records the second program on a hard disk (for example, local hard disk) or the like. The memory 165 of the digital television receiver apparatus stores program recording history information (recording history information of the second program) in response to the recording or reserved-recording instruction (instruction from the control device 200) or an actual recording operation (instruction from the control device 200). For example, the recording history information includes information such as identification information (terminal ID or user ID) of the portable terminal 171 or 172, second program identification information (title or program ID of the second program), recording image quality, recording sound quality, recording location (for example, local hard disk), and the like. Likewise, the memory 165 stores program recording history information (recording history information of the second program) in response to the recording or reversed recording instruction of the second program or an actual recording operation based on an operation signal from the remote controller 174. Furthermore, when the portable terminal 171 or 172 records the second program, it transmits program recording history information (recording history information of the second program) to the digital television receiver apparatus, and the memory 165 of the digital television receiver apparatus stores the program recording history information.

For example, the control device 200 (additional information-appended program guide generator 250) generates display information required to display a program guide including a second program cell associated with the program recording history information based on the second program identification information of the second program cell included in the program guide information.

Then, for example, when the digital television receiver apparatus receives program recording history information related to the second program, it can display the program guide including the second program cell by associating the program recording history information with the second program cell corresponding to the second program. For example, when the user selects the second program cell on the program guide using a cursor, pointer, or the like, the digital television receiver apparatus outputs (pops up) the program recording history information (for example, AI8 in FIG. 7) associated with the second program cell in response to the selection. Alternatively, the digital television receiver apparatus outputs (displays) an icon (program recording history information) associated with the second program cell.

In the same manner as described above, the digital television receiver apparatus can display a program guide including a predetermined program cell by associating program recording history information (for example, AI9 or AI10 in FIG. 7) with the predetermined program cell corresponding to a predetermined program. That is, the digital television receiver apparatus can display that a fifth program has been recorded by an external device via a network, the fifth program recorded on the external device is playable, recording of the fifth program is reserved by the external device, and so forth.

The digital television receiver apparatus can accept a user ID and can operate in a user-dependent mode. For example, when the digital television receiver apparatus accepts a first user ID, it operates in a first user mode. In this case, the digital television receiver apparatus can display a program guide which reflects program recording history information including the first user ID. For example, when the portable terminal 171 or 172 transmits a recording or reserved-recording instruction including the first user ID, the digital television receiver apparatus can display a program guide which reflects the program recording history information including the first user ID.

(Collection and Output of Program Playback History Information)

For example, when the portable terminal 171 or 172 issues a playback or reserved-playback instruction of a third program (a broadcast program, recorded program, network distribution program, program on a package medium, or the like) to the digital television receiver apparatus, the recording/playback controller 141 of the digital television receiver apparatus acquires the third program based on the playback or reserved-playback instruction of the third program. The memory 165 of the digital television receiver apparatus stores program playback history information (playback history information of the third program) in response to the playback or reserved-playback instruction (instruction from the control device 200) or an actual playback operation (instruction from the control device 200). For example, the program playback history information includes identification information (terminal ID or user ID) of the portable terminal 171 or 172, and third program identification information (title or program ID of the third program). Likewise, the memory 165 stores program playback history information (playback history information of the third program) in response to the playback or reserved-playback instruction or an actual recording operation based on an operation signal from the remote controller 174. Furthermore, when the portable terminal 171 or 172 plays back the third program, it transmits program playback history information (playback history information of the third program) to the digital television receiver apparatus, and the memory 165 of the digital television receiver apparatus stores the program playback history information.

For example, the control device 200 (additional information-appended program guide generator 250) generates display information required to display a program guide including a third program cell associated with the program playback history information based on the third program identification information of the third program cell included in the program guide information.

Then, for example, when the digital television receiver apparatus receives the program playback history information related to the third program, it can display the program guide including the third program cell by associating the program playback history information with the third program cell corresponding to the third program. For example, when the user selects the third program cell on the program guide using a cursor, pointer, or the like, the digital television receiver apparatus outputs (pops up) the program playback history information (for example, AI1 in FIG. 6) associated with the third program cell in response to the selection. Alternatively, the digital television receiver apparatus outputs (displays) an icon (program playback history information) associated with the third program cell.

When the program playback history information includes deletion information (deletion of the third program) in addition to the above information (that is, the program playback history information is post-program playback deletion history information), the digital television receiver apparatus can display the program guide including the third program cell by associating the program playback history information (for example AI1 in FIG. 7) with the third program cell corresponding to the third program. For example, when the user selects the third program cell on the program guide using a cursor, pointer, or the like, the digital television receiver apparatus outputs (pops up) the program playback history information (for example, AI1 in FIG. 7) associated with the third program cell in response to the selection. Alternatively, the digital television receiver apparatus outputs (displays) an icon (program playback history information) associated with the third program cell.

The digital television receiver apparatus can accept a user ID and can operate in a user-dependent mode. For example, when the digital television receiver apparatus accepts the first user ID, it operates in the first user mode. In this case, the digital television receiver apparatus can display a program guide which reflects program playback history information including the first user ID. For example, when the portable terminal 171 or 172 transmits a playback or reserved-playback instruction including the first user ID, the digital television receiver apparatus can display a program guide which reflects the program playback history information including the first user ID.

(Collection and Output of Program Purchase History Information)

For example, when the portable terminal 171 or 172 issues a purchase instruction of a fourth program (a network distribution program, program provided in the form of a package medium, or the like) to the digital television receiver apparatus, the control device 200 and transmission/reception unit 161 or 162 of the digital television receiver apparatus transmit a purchase request of the fourth program to an external server or the like, and receive the fourth program provided from the external server. The memory 165 of the digital television receiver apparatus stores program purchase history information (purchase history information of the fourth program) in response to the purchase instruction or purchase request of the fourth program (instruction from the control device 200) or actual purchase processing (instruction from the control device 200). For example, the program purchase history information includes identification information (terminal ID or user ID) of the portable terminal 171 or 172, fourth program identification information (title or program ID of the fourth program), and a purchase form (network distribution program, or purchase of a DVD or BD). Likewise, the memory 165 stores program purchase history information (purchase history information of the fourth program) in response to the purchase instruction of the fourth program or actual purchase processing based on an operation signal from the remote controller 174. Furthermore, when the portable terminal 171 or 172 purchases (executes purchase processing of) the fourth program in response to a user's purchase operation, it transmits program purchase history information (purchase history information of the fourth program) to the digital television receiver apparatus, and the memory 165 of the digital television receiver apparatus stores the program purchase history information.

For example, the control device 200 (additional information-appended program guide generator 250) generates display information required to display a program guide including a fourth program cell associated with the program purchase history information based on the fourth program identification information of the fourth program cell included in the program guide information.

Then, for example, when the digital television receiver apparatus receives the program purchase history information related to the fourth program, it can display the program guide including the fourth program cell by associating the program purchase history information with the fourth program cell corresponding to the fourth program. For example, when the user selects the fourth program cell on the program guide using a cursor, pointer, or the like, the digital television receiver apparatus outputs (pops up) the program purchase history information (for example, AI2 in FIG. 6) associated with the fourth program cell in response to the selection. Alternatively, the digital television receiver apparatus outputs (displays) an icon (program purchase history information) associated with the fourth program cell.

The digital television receiver apparatus can accept a user ID and can operate in a user-dependent mode. For example, when the digital television receiver apparatus accepts the first user ID, it operates in the first user mode. In this case, the digital television receiver apparatus can display a program guide which reflects program purchase history information including the first user ID. For example, when the portable terminal 171 or 172 transmits a purchase instruction including the first user ID, the digital television receiver apparatus can display a program guide which reflects the program purchase history information including the first user ID.

Note that bought-out case of the fourth program has been explained. Also, the same applies to a case in which the playback right of the fourth program is acquired using a video-on-demand (VOD) service. For example, the control device 200 (additional information-appended program guide generator 250) generates display information required to display a program guide including the fourth program cell associated with program viewing-permission information (program streaming distribution purchase information) based on the fourth program identification information of the fourth program cell included in the program guide information.

Then, for example, the digital television receiver apparatus can display the program guide including the fourth program cell by associating the program viewing-permission information with the fourth program cell corresponding to the fourth program. For example, when the user selects the fourth program cell on the program guide using a cursor, pointer, or the like, the digital television receiver apparatus outputs (pops up) the program viewing-permission information (for example, AI3 in FIG. 6) associated with the fourth program cell in response to the selection. Alternatively, the digital television receiver apparatus outputs (displays) an icon (program viewing-permission information) associated with the fourth program cell.

For example, when the digital television receiver apparatus accepts the first user ID, it operates in the first user mode. In this case, the digital television receiver apparatus can display a program guide which reflects the program viewing-permission information including the first user ID.

(Collection and Output of Program Sale Information)

For example, the portable terminal 171 or 172 receives an EPG, and collects items of program sale information based on a plurality of items of program identification information included in the EPG. A case will be described below wherein items of program sale information (items of sale information of a fifth program) are to be collected based on fifth program identification information (title or program ID of the fifth program) included in the EPG for the sake of simplicity. For example, the portable terminal 171 or 172 collects items of program sale information (sale of the fifth program via a network or sale of the fifth program provided in the form of package media), and transmits them to the digital television receiver apparatus. Alternatively, the digital television receiver apparatus receives the EPG, and collects items of program sale information based on the fifth program identification information included in the EPG. For example, the digital television receiver apparatus collects items of program sale information (sale of the fifth program via a network or sale of the fifth program provided in the form of package media). The memory 165 of the digital television receiver apparatus stores the items of program sale information transmitted from the portable terminal 171 or 172 or collected by the self apparatus. For example, the program sale information includes the fifth program identification information (title or program ID of the fifth program), a selling form (network distribution program, DVD sales, or BD sales), and an ad (DVD sale or the like).

For example, the control device 200 (additional information-appended program guide generator 250) generates display information required to display a program guide including a fifth program cell associated with the program sale information based on the fifth program identification information of the fifth program cell included in the program guide information.

Then, for example, when the digital television receiver apparatus acquires program sale information related to the fifth program, it can display the program guide including the fifth program cell by associating the program sale information with the fifth program cell corresponding to the fifth program. For example, when the user selects the fifth program cell on the program guide using a cursor, pointer, or the like, the digital television receiver apparatus outputs (pops up) the program sale information (for example, AI4 in FIG. 6) associated with the fifth program cell in response to the selection. Alternatively, the digital television receiver apparatus outputs (displays) an icon (program sale information) associated with the fifth program cell.

Note that the sale case of the fifth program has been described. Also, the same applies to a case in which the playback right of the fifth program is commercially available using a video-on-demand (VOD) service. For example, when the digital television receiver apparatus acquires VOD information (program streaming distribution information) related to the fifth program, it can display the program guide including the fifth program cell by associating the VOD information with the fifth program cell corresponding to the fifth program. For example, when the user selects the fifth program cell on the program guide using a cursor, pointer, or the like, the digital television receiver apparatus outputs (pops up) the VOD information (for example, A15 in FIG. 6) associated with the fifth program cell in response to the selection. Alternatively, the digital television receiver apparatus outputs (displays) an icon (VOD information) associated with the fifth program cell.

(Collection and Output of Network Access Information)

For example, the portable terminal 171 or 172 receives an EPG, searches for items of related information (postings on a message board, information on Twitter, that on Facebook, etc.) of a sixth program on the network based on sixth program identification information (title or program ID of the sixth program) included in the EPG so as to collect items of access information (addresses such as URLs) to the items of related information of the sixth program, and transmits them to the digital television receiver apparatus. Alternatively, the digital television receiver apparatus receives the EPG, and searches for items of related information of the sixth program on the network to collect items of access information (addresses such as URLs) to the items of related information of the sixth program. The memory 165 of the digital television receiver apparatus stores the items of access information transmitted from the portable terminal 171 or 172 or collected by the self apparatus. For example, each access information required to access corresponding related information of the sixth program on the network includes sixth program identification information and an address such as a URL.

For example, the control device 200 (additional information-appended program guide generator 250) generates display information required to display a program guide including a sixth program cell associated with the access information based on the sixth program identification information of the sixth program cell included in the program guide information.

Then, for example, when the digital television receiver apparatus acquires access information of the sixth program, it can display the program guide including the sixth program cell by associating the access information with the sixth program cell corresponding to the sixth program. For example, when the user selects the sixth program cell on the program guide using a cursor, pointer, or the like, the digital television receiver apparatus outputs (pops up) the access information (for example, AI6 or AI7 in FIG. 6) associated with the sixth program cell in response to the selection. Alternatively, the digital television receiver apparatus outputs (displays) an icon (access information) associated with the sixth program cell.

(Collection and Output of Network Program Provision Information)

For example, the portable terminal 171 or 172 receives an EPG, and searches for program provision information (distribution information of a seventh program or the like) of the seventh program on the network based on seventh program identification information (title or program ID of the seventh program) included in the EPG to check whether or not the seventh program is distributed. When the seventh program is distributed (when the portable terminal 171 or 172 finds the program provision information of the seventh program), the portable terminal 171 or 172 transmits the program provision information of the seventh program to the digital television receiver apparatus. Alternatively, the digital television receiver apparatus receives the EPG, and searches for program provision information of the seventh program on the network based on the seventh program identification information included in the EPG to check whether or not the seventh program is distributed. The memory 165 of the digital television receiver apparatus stores the program provision information transmitted from the portable terminal 171 or 172 or found by the self apparatus. For example, the program provision information includes the seventh program identification information and an address such as a URL of a distribution source.

For example, the control device 200 (additional information-appended program guide generator 250) generates display information required to display a program guide including a seventh program cell associated with the program provision information based on the seventh program identification information of the seventh program cell included in the program guide information.

Then, for example, when the digital television receiver apparatus acquires program provision information of the seventh program, it can display the program guide including the seventh program cell by associating the program provision information with the seventh program cell corresponding to the seventh program. For example, when the user selects the seventh program cell on the program guide using a cursor, pointer, or the like, the digital television receiver apparatus outputs (pops up) the program distribution information (for example, AI7 in FIG. 6) associated with the seventh program cell in response to the selection. Alternatively, the digital television receiver apparatus outputs (displays) an icon (program distribution information) associated with the seventh program cell.

As described above, the digital television receiver apparatus can append various kinds of information to a program guide such as an EPG or program recording list, and can output (pop up) it as an additional information-appended program guide.

For example, the digital television receiver apparatus can notify the user of the following items of information by outputting the additional information-appended program guide.

(1) The apparatus can notify the user that there is a purchased DVD or BD corresponding to a certain program (program cell) in the additional information-appended program guide.

(2) The apparatus can notify the user of a viewing history of a certain program (program cell) in the additional information-appended program guide.

(3) The apparatus can notify the user that there is a rental DVD or BD or sell DVD or BD corresponding to a certain program (program cell) in the additional information-appended program guide.

(4) The apparatus can present a link (a link button to Twitter or Facebook) to related information of a certain program (program cell) in the additional information-appended program guide to the user.

(5) The apparatus can notify the user that a certain program (program cell) in the additional information-appended program guide is playable on a VOD service (it is playable immediately without waiting until a broadcast time).

Conventionally, the EPG displays a list of programs to be broadcast from the present time, and the user searches a plurality of program cells on the EPG for a program of interest, and reserves recording (video recording) or playback (viewing) of that program. That is, the user uses the EPG mainly for the purpose of searching for a program of interest.

For example, when there are movie titles T1 to Tn in a series, the user often does not remember which of movie titles T1 to Tn has already been viewed, has already been recorded, or have neither been viewed nor recorded. Also, the user often does not remember recording quality of a certain movie title T2 although he or she has recorded that title. That is, although the user has definitely recorded movie title T2, he or she often does not remember whether or not that title has been recorded with or without commercials, as a full-length version, to have SD or HD image quality, or as a 3D video.

In order to confirm the recording quality or the like of recorded movie title T2, the user often wants to play back recorded movie title T2. If recorded title T2 has been recorded to have SD image quality, the user may want to re-record that title to have HD quality. Also, if title T2 has been recorded as a 2D video, the user may want to re-record that title as a 3D video.

If there are 3000 programs per week, the user wants to know various kinds of information about these 3000 programs. Especially, the user wants to know information about programs of interest.

The aforementioned digital television receiver apparatus can provide information (additional information) about programs of interest of the user. As described above, the digital television receiver apparatus can receive and collect items of history information of previous actions and behaviors of the user, and can output a history information-appended program guide (that is, additional information-appended program guide) which reflects these items of history information.

For example, the digital television receiver apparatus can display, on the program guide, a play start button in association with a program cell of a recorded program, and can also display information such as a saving destination library number or disk number of a recorded program in association with the recorded program (program cell). Furthermore, the digital television receiver apparatus can display, on the program guide, information indicating that a certain program is playable (viewable) immediately in association with a program cell of a VOD-provided program.

Alternatively, when the user selects an icon corresponding to the additional information, a function corresponding to the additional information may be executed. For example, when the user selects an icon corresponding to program recording history information, playback of a recorded program is started. When the user selects an icon corresponding to program purchase history information, playback of a purchased program is started. When the user selects an icon corresponding to program viewing-permission information (program streaming distribution purchase information), playback of a viewing-permission program is started. When the user selects an icon corresponding to program sale information, a program purchase procedure screen is displayed. When the user selects an icon corresponding to network access information, an access to information on the network is started based on the network access information. When the user selects an icon corresponding to network program provision information, a playback procedure screen of a program on the network is displayed.

A display format (color, size, etc.) of additional information may be changed depending on types of additional information. Also, a plurality of items of additional information can be displayed in association with one program cell. Items of additional information are collected using the aforementioned preference information collection technique, and the items of collected additional information can be reflected to a program guide. A program cell appended with additional information corresponding to preference information can also be displayed distinctly from other program cells. For example, a display color of the program cell appended with the additional information corresponding to the preference information may be set to be different from that of other program cells.

As described above, the digital television receiver apparatus can display a program guide which reflects user-dependent additional information using a user ID transmitted from the portable terminal 171 or 172. For example, the portable terminal 171 or 172 transmits a user ID used in login processing. The digital television receiver apparatus can display user identification information corresponding to the user ID transmitted from the portable terminal 171 or 172 and also an additional information-appended program guide corresponding to the user ID transmitted from the portable terminal 171 or 172.

Alternatively, when the portable terminal 171 or 172 displays an additional information-appended program guide, it may display a user-dependent program guide corresponding to a user ID used in login processing, and when the digital television receiver apparatus displays an additional information-appended program guide, it may display a user-independent program guide.

The additional information-appended program guide based on the EPG and recording list has been described. Alternatively, a program additional information-appended combined playback list may be displayed.

For example, the digital television receiver apparatus accepts input search keywords and extracts those from preference information in advance, thus searching for programs including the search keywords. The digital television receiver apparatus searches for programs including the search keywords based on an EPG, recording list (recording history), playback list (playback history), search history, recording list (recording history) of another device, playback list (playback history) of the other device, search history of the other device, DVD/BD sale list, DVD/BD rental list, and metadata included in a program list provided by a VOD service, and displays found programs as a recommended list (combined playback list).

For example, when the user inputs desired search keywords to the portable terminal 171 or 172, the portable terminal 171 or 172 transmits the desired search keywords to the digital television receiver apparatus. The digital television receiver apparatus searches the EPG, recording list, playback list, recording list of another device, playback list of the other device, DVD/BD sale list, DVD/BD rental list, and program list provided by the VOD service for programs corresponding to the desired search keywords, and displays the search result as a combined playback list. In this way, since the user need only input desired search keywords, he or she can view the combined playback list corresponding to the desired search keywords. When the user selects a program from the combined playback list, he or she can view the program corresponding to the desired keywords. For example, programs related to a desired artist can be displayed as a combined playback list.

Alternatively, the portable terminal 171 or 172 may search the EPG, recording list, playback list, recording list of another device, playback list of the other device, DVD/BD sale list, DVD/BD rental list, and program list provided by the VOD service for programs corresponding to desired search keywords, and may display the search result as a combined playback list. In this case, the portable terminal 171 or 172 may play back a program selected on the combined playback list, or may transfer the selected program to the digital television receiver apparatus, which may play back the selected program.

In addition, on the combined playback list, the aforementioned additional information is appended, resulting in a high utility value.

The case has been described above wherein the combined playback list is displayed based on input search keywords. Alternatively, the combined playback list may be displayed based on preference information (without any input search keywords). That is, the combined playback list can be displayed based on search keywords corresponding to the preference information.

The case has been described above wherein programs found based on search keywords are displayed on the combined playback list. Furthermore, ad information found based on search keywords may be displayed on the combined playback list. That is, a combined playback list including a recommended list and ad information may be displayed.

Moreover, access information to a community area found based on search keywords and information of that community area may be displayed on the combined playback list. That is, a combined playback list including a recommended list, ad information, access information to a community area, and information of that community area may be displayed.

In addition, as described above, the digital television receiver apparatus or portable terminal 171 or 172 can display a user-dependent combined playback list based on a user ID.

According to at least one embodiment, an information processing apparatus and information processing method, which can output an additional information-appended program guide, can be provided.

The technical terms used above in relation to the embodiments and the names or technical terms described in the drawings are in no way restrictive. For example, the processor may be replaced with processing means, a processing unit, or a processing module. Likewise, the controller may be replaced with control means, a control unit, or a control module. The managing unit may be replaced with a manager, managing means, or a managing module. The generator may be replaced with generating means, a generating unit, or a generating module. The storage unit may be replaced with storage means, a recorder or a storage module. The collection and correction unit may be replaced with collection and correction means, or a collection and correction device. The registration unit may be replaced with registration means, a registration device, or a registration module.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a receiver configured to receive program additional information including operation history information;
a generator configured to generate display information required to display a program guide associated with the program additional information based on the program additional information and program guide information; and
an output module configured to output the display information.

2. The apparatus of claim 1, wherein the receiver is configured to receive the program additional information including first program identification information, and
the generator is configured to generate, based on the first program identification information of a first program cell included in the program guide information, the display information required to display the program guide including the first program cell associated with the program additional information.

3. The apparatus of claim 1, wherein the receiver is configured to receive program recording history information including second program identification information, and
the generator is configured to generate, based on the second program identification information of a second program cell included in the program guide information, the display information required to display the program guide including the second program cell associated with the program recording history information.

4. The apparatus of claim 1, wherein the receiver is configured to receive program playback history information including third program identification information, and
the generator is configured to generate, based on the third program identification information of a third program cell included in the program guide information, the display information required to display the program guide including the third program cell associated with the program playback history information.

5. The apparatus of claim 1, wherein the receiver is configured to receive program purchase history information including fourth program identification information, and
the generator is configured to generate, based on the fourth program identification information of a fourth program cell included in the program guide information, the display information required to display the program guide including the fourth program cell associated with the program purchase history information.

6. The apparatus of claim 1, wherein the receiver is configured to receive program sale information including fifth program identification information, and
the generator is configured to generate, based on the fifth program identification information of a fifth program cell included in the program guide information, the display information required to display the program guide including the fifth program cell associated with the program sale information.

7. The apparatus of claim 1, wherein the receiver is configured to receive network access information including sixth program identification information, and
the generator is configured to generate, based on the sixth program identification information of a sixth program cell included in the program guide information, the display information required to display the program guide including the sixth program cell associated with the network access information.

8. The apparatus of claim 1, wherein the receiver is configured to receive network program provision information including seventh program identification information, and
the generator is configured to generate, based on the seventh program identification information of a seventh program cell included in the program guide information, the display information required to display the program guide including the seventh program cell associated with the network program provision information.

9. The apparatus of claim 1, wherein the receiver is configured to receive the program guide information, and
the generator is configured to generate the display information required to display the program guide based on the received program guide information.

10. The apparatus of claim 1, wherein the generator is configured to generate the display information required to display the program guide based on the program guide information corresponding to a program recording list.

11. The apparatus of claim 2, wherein the output module is configured to output the program additional information associated with the first program cell in response to a selection operation of the first program cell.

12. The apparatus of claim 1, wherein the receiver is configured to receive the program additional information including user identification information, and
the generator is configured to generate the display information required to display the program guide corresponding to the user identification information.

13. An information processing method comprising:
receiving program additional information;
generating display information required to display a program guide associated with the program additional information based on the program additional information and program guide information; and
outputting the display information.
